(19) United States
(12) Patent Application Publication
(10) Pub. No.: US 2004/0262206 A1
(43) Pub. Date: Dec. 30, 2004

(54) Mobile field electrical supply, freshwater and saltwater purification system, powder wash, wash station, and water collection and reclamation apparatus

(76) Inventor: Doug Gettman, Columbus, OH (US)

Correspondence Address: GALLAGHER & DAWSEY CO., L.P.A., P.O. BOX 785, COLUMBUS, OH, 43216, US

(21) Appl. No.: 10/607,775

(22) Filed: Jun. 27, 2003

(51) Int. Cl. B01D 17/12

(52) U.S. Cl. 210/143; 210/182; 210/241; 210/259

(57) ABSTRACT

A mobile field electrical supply, freshwater and saltwater purification system, power wash, wash station, and water collection and reclamation apparatus provides water collection, handling, treatment, and storage capacity. The apparatus comprises a raw water filtration system, a sodium ion exchange system, a storage system with a plurality of tanks, a reverse osmosis system, and heating and distributions systems. The apparatus also comprises a mobile electrical power system. Optionally, the apparatus includes a desalination system, a disinfection system, a rainwater collection system, a fluid containment and recovery system, and an auxiliary fluid distribution system. The disinfection system may include a chlorination, ultraviolet light, or ozone disinfection system, and may further include a distillation system that may be conventionally powered or solar powered. Water may be distributed through a plurality of auxiliary devices, including pressure pumps, heaters, fluid lines, power wash equipment, shower heads, and associated air powered tools.

### TECHNICAL FIELD

The present invention relates to the field of water treatment, in particular, to a mobile field water treatment system capable of supplying multiple water needs.

### BACKGROUND OF THE INVENTION

Many personal, commercial, and industrial applications require a source of clean water. However, this clean water may not be available, especially under field conditions. Additionally, these same applications may generate waste water that is contaminated with varying levels of such items as hydrocarbons, detergents, or minerals. Again, under field conditions, there maybe no practical means for safely disposing of such waste water. Even if water is available and contaminated water may be discharged, the supply of water under field conditions may be inadequate unless collected and immediately recycled during use. Under other conditions, heavily or dangerously contaminated waste water may need to be collected and stored for eventual removal.

The current art has failed to provide for these requirements in a convenient, mobile, and cost-effective manner. The instant invention relates to apparatus in a basic system concept of self contained water purification, storage, and recycling system where all the required collection, processing, storage, and control units are contained in one highly mobile, simple and efficiently operating unit. An optimal field apparatus would be highly mobile and easily transported into relatively remote areas and would have the capacity to operate independently of fixed power supplies, as well as to provide and distribute power external to the apparatus. The apparatus would have storage capacity to both bring water into the field, and to store both processed water and used water, should circumstances so require. The apparatus would have a collection system capable of collecting environmental water, and if desired, for collecting water used on site. The apparatus would have a raw water filtration system, capable of processing environmental or recycled water, separating and filtering contaminants, to provide a raw water source. Environmental water could be collected from standing sources such as ponds, lakes, streams, or wells, or could be supplied by catchments from such sources as rainwater. Optionally, the apparatus could include water softening capacity, reverse osmosis, desalination, water deionization, chlorination or other purification means, and water heating capacity. Further options could include pressure boosting pumps, solar arrays to provide electrical power capacity, and air compressors. The apparatus would be self-contained as to the necessary electrical generation capacity; pumping, piping, valving, hoses, sprayers and other distribution means; while containing all the above in a mobile platform that could be operated by a single person. The instant invention accomplishes these goals.

### SUMMARY OF INVENTION

In its most general configuration, the present invention advances the state of the art with a variety of new capabilities and overcomes many of the shortcomings of prior devices in new and novel ways. In its most general sense, the present invention overcomes the shortcomings and limitations of the prior art in any of a number of generally effective configurations. The instant invention demonstrates such capabilities and overcomes many of the shortcomings of prior methods in new and novel ways.

In one of the simplest configurations, the mobile field electrical supply, water storage, recovery, and treatment apparatus of the present invention comprises a raw water filtration system, a sodium ion exchange system, a reverse osmosis system, a storage system, a desalination system, a heating system, a distribution system, a piping system, a mobile electrical power system, and a vehicle for transporting the various elements. This gives the invention the capacity to provide a customizable array of water handling facilities that may be tailored to specific requirements of field situations.

Just one of many unique features of the present invention is that the entire apparatus is highly mobile via the vehicle which may be trailer pulled by another vehicle or a self-powered vehicle such as a truck. In one particular embodiment, all of the various components fit nicely in a twenty-four foot long box truck.

Generally, the first treatment that water receives from the apparatus is from the raw water filtration system. Water may enter the raw water filtration system in any number of ways such as, by way of example and not limitation, rainwater collection systems, fluid containment and recovery systems, and essentially any standing water source such as lakes and streams. Most commonly the vehicle will be located next to a lake or stream such that one may attach a hose from the raw water filtration system to a submersible pump that is placed in the lake or stream. Such raw water is then pumped into the raw water filtration system.

The raw water filtration system removes as much suspended solids from the raw water as possible, incorporating gravity, pressure, diatomaceous, or other filters. The raw water filtration system may be as simple as gravity sand or diatomaceous earth filters. Alternatively, pressure filter systems with automated backwash features may also be incorporated. The raw water filtration system may incorporate elements designed to aide in the separation of oil and grease from the water. A discharge pump may then be used to pump the water through at least one final filter and out the raw water outlet, and in one preferred embodiment; the final filter consists of a number of polishing filters gradually filtering the water of particles down to 5 microns in size. The various elements of the raw water filtration system are reusable and easy to clean and the raw water system has a means for easily draining the system.

The system has the capacity to direct water emerging from the raw water filtration system to various other handling components, depending on the exact requirements of the project at hand. If the goal is to produce potable water, the piping system will then direct the water to the sodium ion exchange system which will reduce the mineral content, specifically the calcium and magnesium content, of the water by a process of ion exchange.

The water flow path leaving the sodium ion exchange system depends upon the desired quality of the water. Generally the water leaving the sodium ion exchange system will either be directed to the storage system or to the reverse osmosis system. The reverse osmosis system may include a RO pump, a RO pre-filter, and a RO membrane to produce high purity water. The RO pre-filter serves to remove suspended solids generally of five microns in size and larger that may damage the RO membrane. Many reverse osmosis systems incorporate numerous prefilters. Often, one prefilter will include a replaceable carbon cartridge to reduce the amount of chlorine. In most embodiments a RO pump is required to elevate the pressure of the water so as to overcome the osmotic pressure of the RO membrane and force the water through it. The product water, that is, water leaving the RO system, has least 87% of lead, 80% of calcium, 80% of magnesium, 90% of iron, 96% of lead, and 95% of total dissolved solids removed from the incoming water. The reverse osmosis system may also include final polishing by activated carbon, mixed-bed deionization, and/or sub-micron membrane filtration.

The product water is generally then delivered to the storage system until such time as final distribution is needed. The storage system consists of at least one storage tank, more commonly at least two storage tanks; at least one potable water tank and at least one non-potable water tank. For instance, the apparatus may be configured with numerous non-potable water tanks such that the user may quickly acquire and store a large volume of non-potable water, such as from a lake or stream, and then utilize the other elements of the apparatus to bring the raw water up to potable water standards. Additionally, there are applications such as vehicle washing in which softened water is desired, yet it need not be potable. In such an application raw water may be rapidly acquired and placed in raw water tanks to later be softened by the sodium ion exchange system and stored in a softened non-potable water tank.

The apparatus may incorporate a disinfection system, since while the reverse osmosis system removes the bulk of the dissolved solids and ionized impurities, it does not completely remove bacteria, viruses, and pyrogens. The disinfection system may include, by way of example and not limitation, a chlorination system which may inject chlorine gas or liquid chlorine into the water, an ultraviolet light disinfection system, or an ozone disinfection system. Alternatively, the apparatus may incorporate a distillation system to guarantee that the water is free of organics, undissolved solids, biological contaminants, including pyrogens, and practically all ionizables. The distillation system may incorporate any number of distillation systems including, but not limited to, a single-effect distillation system and a solar distillation system. Regardless of the particular embodiment, the principle of distillation is that water must pass through two phase changes, from liquid to vapor and back to liquid.

Water may then exit the storage system by gravity flow or via a booster pump system. In one simple embodiment the booster pump system may consist of little more than a submersible pump and associated controls. More advanced embodiments may include numerous positive displacement high pressure pumps. Use of high pressure pumps provides several advantages. Having the capability of producing pressures of several thousand pounds per square inch permits the use of such high pressure water as a tool both for cleaning and cutting, as well as reduced pressure distribution.

The water may then pass through a heating system or go directly to a distribution system. In low pressure applications, those with pressures of less than about one hundred and twenty psi, common water heating devices may be used. In high pressure applications, those ranging from about one hundred and twenty psi up to several thousand psi, special water heating systems must generally be used. It is generally desirable for the heating system to have the capability of producing at least a 100 degree F. temperature rise at the booster pump system optimal flow rate. It is generally preferred for the heating system to utilize the same fuel as the vehicle and the mobile electrical power system, namely, diesel fuel. The heating system may include adjustable thermostatic control as well as high-temperature and high-pressure protective devices.

The water may then proceed to the distribution system. The distribution system may incorporate final point of consumption devices, such as shower heads, spigots, and drinking fountains, as well as mechanisms for connection to other bulk distribution equipment, such as quick-connect hose couplings. Such final point of consumption devices may incorporate a number of safety features including, but not limited too, scald protection and high pressure protection. In one particular embodiment, a plurality of shower heads are mounted on the side of the vehicle in such a fashion as to be adjustable in height to facilitate use by adults and children. For power washing, the distribution system may include a plurality of high pressure hoses, a high pressure spray gun, numerous pressure nozzles, foaming attachments, underbody spray attachments, brush attachments, and drain cleaning attachments.

The mobile electrical power system of the instant invention generates electrical power for use by all the power consuming devices in the apparatus, and is able to provide and distribute power external to the apparatus. The apparatus may further include a solar energy collection system in electrical communication with at least the mobile electrical power system. The solar energy collection system may be used to maintain the charge of any batteries associated with the mobile power system or the vehicle.

The apparatus may also include a desalination system, separate from the RO system, enabling the instant invention to utilize sea water or highly brackish water, as well as sources from contaminated lakes or streams detailed above, in a more efficient manner.

Alternative embodiments of the apparatus may include a compressed air system and/or an auxiliary fluid distribution system. The compressed air system may incorporate an air compressor, storage tank, distribution hoses, and associated compressed air tools. The auxiliary fluid distribution system may include accessories for distributing fluids other than those previously described. Such fluids may include fluids such as cleaning agents and fuels that should be distributed entirely independent of the water systems. In yet another alternative embodiment, the apparatus may include a rain water collection system. Water captured in the rain water collection system may then be transferred to the storage system for later processing, or may be transferred directly to the raw water filtration system. A further embodiment may include a fluid containment and recovery system to minimize the amount of water wasted as run-off and allowing the instant invention to operate with a minimum of new water input.

The control of the apparatus may be entirely automated with pneumatic or electronic controls. Numerous sensors may be installed throughout the apparatus to continuously monitor, and record, the characteristics of the water at various points in the apparatus. Additionally, for severe duty applications, each component of the apparatus may be installed for redundant operation thereby creating a full back-up system.

In sum, the instant invention provides a heretofore unavailable capacity to collect, handle, store, and recycle water under field conditions with a flexible range of water treatment options. The system is highly self-contained and mobile, and may easily be transported into the field. The simplicity of operation of the system makes it highly amenable to operation by a single operator.

### BRIEF DESCRIPTION OF THE DRAWINGS

Without limiting the scope of the present invention as claimed below and referring now to the drawings and figures:

FIG. 1 shows a schematic diagram of an embodiment of the instant invention;

FIG. 2 shows a schematic diagram of an alternate embodiment of the instant invention;

FIG. 3 shows one variation of the raw water filtration system in top plan view, not to scale;

FIG. 4 shows a schematic diagram of an alternative embodiment of the instant invention including a distillation system and a compressed air system;

FIG. 5 shows a schematic diagram of one variation of the distillation system, namely a single-effect distillation system;

FIG. 6 shows a schematic diagram of another variation of the distillation system, namely a solar distillation system;

FIG. 7 shows a schematic diagram of an alternative embodiment of the instant invention including a disinfection system;

FIG. 8 shows a schematic diagram of one variation of the RO prefilter and RO membrane;

FIG. 9 shows a side elevation view of one embodiment of the vehicle of the instant invention, showing shower heads on the side of the vehicle;

FIG. 10 shows a schematic diagram of the apparatus of FIG. 1, further including a rainwater collection system;

FIG. 11 shows a fluid containment and recovery system of an alternative embodiment of the instant invention; and

FIG. 12 shows a front elevation view of a control panel embodiment of the instant invention.

### DETAILED DESCRIPTION OF THE INVENTION

The instant invention enables a significant advance in the state of the art. The preferred embodiments of the apparatus accomplish this by new and novel arrangements of elements and methods that are configured in unique and novel ways and which demonstrate previously unavailable but preferred and desirable capabilities. The detailed description set forth below in connection with the drawings is intended merely as a description of the presently preferred embodiments of the invention, and is not intended to represent the only form in which the present invention may be constructed or utilized. The description sets forth the designs, functions, means, and methods of implementing the invention in connection with the illustrated embodiments. It is to be understood, however, that the same or equivalent functions and features may be accomplished by different embodiments that are also intended to be encompassed within the spirit and scope of the invention.

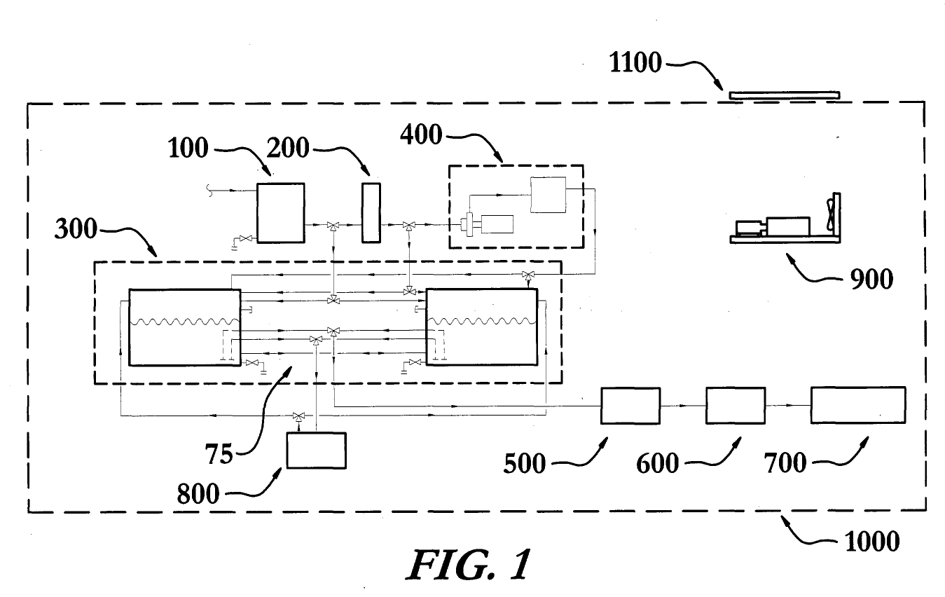

In one basic embodiment, the mobile field electrical supply, water storage, recovery, and treatment apparatus 50 of the present invention comprises a raw water filtration system 100, a sodium ion exchange system 200, a reverse osmosis system 400, a storage system 300, a desalination system 800, a heating system 600, a distribution system 700, a piping system 75, a mobile electrical power system 900, and a vehicle 1000 for transporting the various elements, as seen in FIG. 1. The piping system 75 has at least one valve and is configured to place various elements of the apparatus 50 in fluid communication. Similarly, the mobile electrical power system 900 is in electrical communication with at least the reverse osmosis system 400, the desalination system 800, and the heating system 600.

Just one of many unique features of the present invention is that the entire apparatus is highly mobile via the vehicle 1000. The vehicle 1000 may take any of a number of forms. For example, the vehicle 1000 may simply be a flatbed trailer upon which the various elements are mounted such that the trailer is pulled by another vehicle 1000. Similarly, a standard enclosed trailer may be used to house and transport the various elements. Conversely, the vehicle 1000 may be a self-powered vehicle such as a truck. In one particular embodiment, all of the various components fit nicely in a twenty-four foot long box truck. Generally, the first treatment that water receives from the apparatus 50 is from the raw water filtration system 100. Water may enter the raw water filtration system 100 in any number of ways that will be discussed in greater detail later, but shall include rainwater collection systems 1500, fluid containment and recovery systems 1600, and essentially any water source such as lakes and streams. Most commonly the vehicle 1000 will be located next to a lake or stream such that one may attach a hose from the raw water filtration system 100 to a submersible pump that is placed in the lake or stream. Such raw water is then pumped into the raw water filtration system 100.

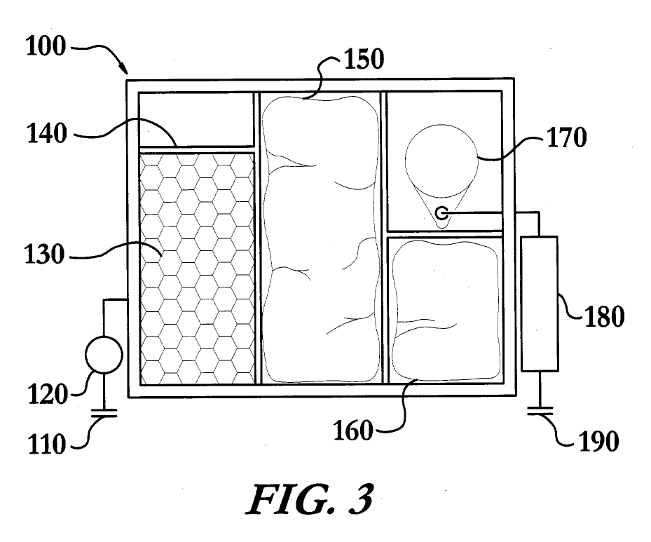

The goal of the raw water filtration system 100 is to remove as much suspended solids from the raw water as possible. The raw water filtration system 100 may incorporate gravity, pressure, and/or diatomaceous filters. As such, the raw water filtration system 100 may be as simple as gravity sand or diatomaceous earth filters. Alternatively, pressure filter systems with automated backwash features may also be incorporated. In one particular embodiment, the raw water filtration system 100 may incorporate elements designed to aide in the separation of oil and grease from the water. One such raw water filtration system 100 is illustrated in FIG. 3. In this particular embodiment, raw water enters the raw water inlet 110 and is directed to a separator 120 to filter out large objects. Depending on the raw water flow rate, the separator 120 may be a centrifugal type or may simply incorporate a large capacity basket strainer. The raw water is then directed to a plurality of coalescing plates 130 to help separate any oil and grease present from the water. Next, the water passes an oil skimmer 140 to further reduce the amount of oil in the water. Reticulated media 150 and filter bags 160 are then exposed to the water to further reduce the amount of suspended solids and to absorb suspended oil. A discharge pump 170 may then be used to pump the water through at least one final filter 180 and out the raw water outlet 190. In one preferred embodiment, the at least one final filter 180 consists of a number of polishing filters gradually filtering the water of particles down to 5 microns in size. It is preferred that the various elements of the raw water filtration system 100 are reusable and easy to clean. Further, the raw water filtration system 100 has a means for easily draining the system.

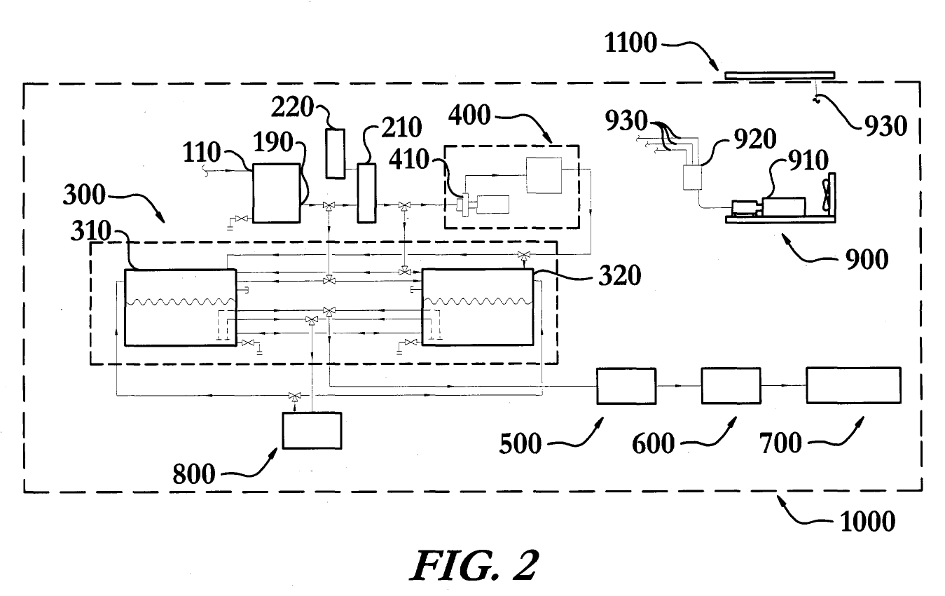

Depending on the desired use of the water leaving the raw water filtration system 100, the piping system 75 then directs it to other systems in the apparatus 50. Most commonly, if the goal is to produce potable water, the piping system 75 will then direct the water to the sodium ion exchange system 200. The sodium ion exchange system 200 will then reduce the mineral content, specifically the calcium and magnesium content, of the water by a process of ion exchange. Referring now to FIG. 2, as the water passes through the sodium ion exchange system 200 the resin in the softener tank 210 is loaded with sodium and the positively charged calcium and magnesium ions are attracted to the negatively charged sodium ions, thus softening the water. The exchange process continues to the point that the resin becomes saturated with calcium and magnesium. A salt brine solution is then transferred from at least one brine tank 220 through the resin to restore its original sodium-loaded status. The at least one brine tank 220 may be a single brine tank 220 that stores salt and makes brine, or it may be a multiple tank configuration wherein one or more tanks store the salt and one or more tanks store the brine solution. The at least one brine tank 220 may include all the electrical and mechanical controls for proper functioning.

The resin in the softener tank 210 may further filter out suspended solids from the water. The sodium ion exchange system 200 may incorporate a backwashing feature to provide intermittent flow through the resin in a direction opposite that of normal flow to remove captured suspended solids and to loosen the resin beads so that it is easier to pass brine through the resin bed. The softener tank 220 is a pressure vessel used to hold the resin and distribute the water over the entire tank area and collect water evenly from all parts of the resin. The softener tank 220 may include the controls necessary for regeneration of the resin bed and for backwashing.

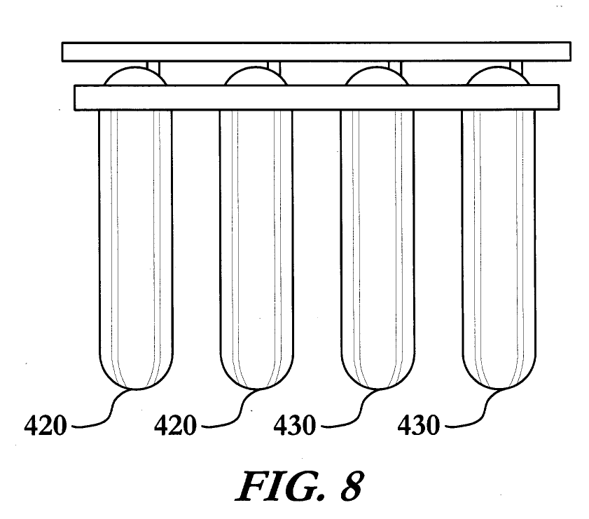

The water flow path leaving the sodium ion exchange system 200 depends upon the desired quality of the water. Generally the water leaving the sodium ion exchange system 200 will either be directed to the storage system 300 or to the reverse osmosis system 400. Referring now to FIG. 8, the reverse osmosis system 400 may include a RO pump 410, a RO pre-filter 420, and a RO membrane 430 to produce high purity water leaving the reverse osmosis system 400. The RO pre-filter 420 serves to remove suspended solids generally of five microns in size and larger that may damage the RO membrane 430. Many reverse osmosis systems 400, such as that shown in FIG. 8, incorporate numerous prefilters. Often one prefilter will include a replaceable carbon cartridge to reduce the amount of chlorine. In most embodiments, a RO pump 410 is required to elevate the pressure of the water so as to overcome the osmotic pressure of the RO membrane 430 and force the water through it. The water that passes through the RO membrane 430 is herein referred to as product water, whereas water that does not pass through the RO membrane 430 and becomes more concentrated with minerals is herein referred to as the concentrate stream. When this occurs the dissolved salts, organics, and colloidal solids are rejected by the RO membrane 430. The product water has least 87% of lead, 80% of calcium, 80% of magnesium, 90% of iron, 96% of lead, and 95% of total dissolved solids removed from the incoming water. In one particular embodiment the RO membrane 430 is constructed of a tubular membrane, a cellulose-acetate sheet membrane, or a polyamide-hollow fiber membrane. The reverse osmosis system 400 may also include final polishing by activated carbon, mixed-bed deionization, and/or sub-micron membrane filtration.

The product water is generally then delivered to the storage system 300 until such time as final distribution is needed. The storage system 300 consists of at least one storage tank 310, more commonly at least two storage tanks; at least one potable water tank 310 and at least one non-potable water tank 320. A variety of tanks and configurations may be utilized depending on the particular application desired. For instance, the apparatus 50 may be configured with numerous non-potable water tanks 320 such that the user may quickly acquire and store a large volume of non-potable water, such as from a lake or stream, and then later utilize the other elements of the apparatus 50 to bring the raw water up to potable water standards. Since it is common to have reverse osmosis systems 400 that have a twenty-five percent recovery rate, a ratio of approximately three non-potable water tanks 320 for every one potable water tank 310 is often preferred. Additionally, there are applications such as vehicle washing in which softened water is desired, yet it need not be potable. In such an application raw water may be rapidly acquired and placed in raw water tanks to later be softened by the sodium ion exchange system 200 and stored in a softened non-potable water tank. The at least one storage tank 310 may include virtually any number of inlet and outlet connections and configurations, including independent drainage systems, as well as inter-tank piping permitting the transfer of fluid between tanks. Additionally, the at least one storage tank 310 may incorporate transfer pumps, generally submersible pumps, to transfer fluid within the apparatus 50.

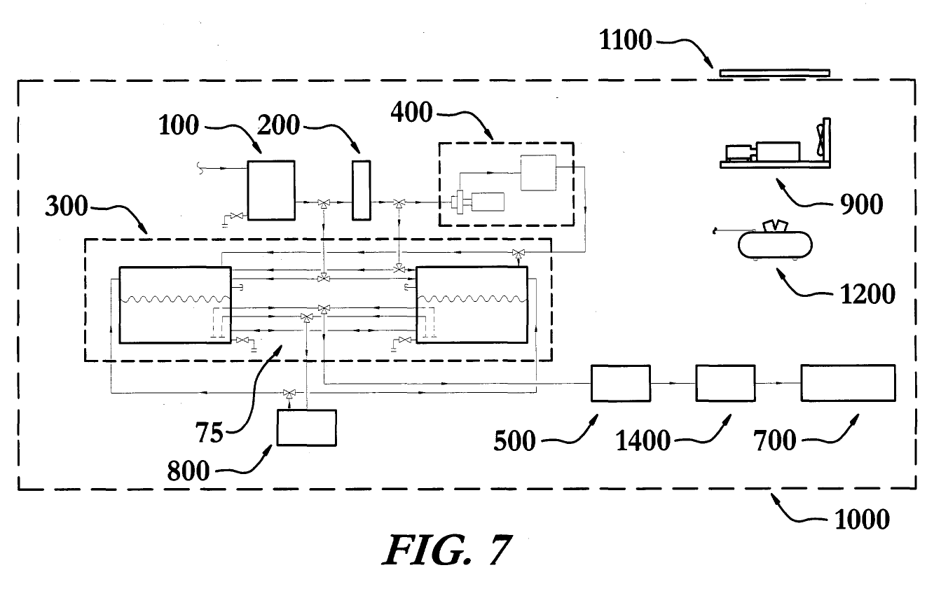

In yet another embodiment, the apparatus 50 may incorporate a disinfection system 1400 in fluid communication with the piping system 75, as seen in FIG. 7. While the reverse osmosis system 400 removes the bulk of the dissolved solids and ionized impurities, it does not completely remove bacteria, viruses, and pyrogens. The disinfection system 1400 is directed toward reducing, or eliminating, the bacteria, viruses, and pyrogens from the water. A variety of technologies may be incorporated into the disinfection system 1400.

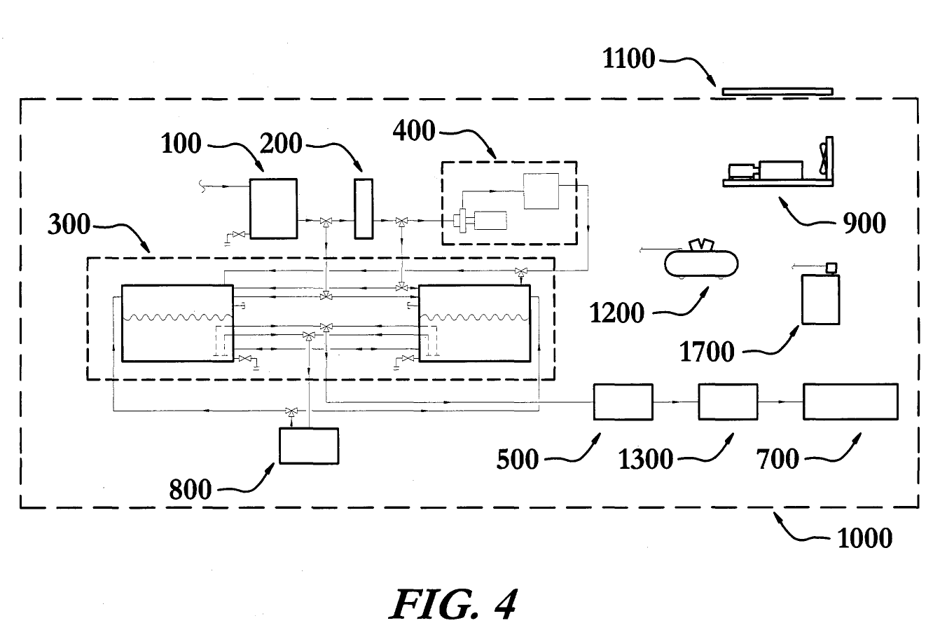

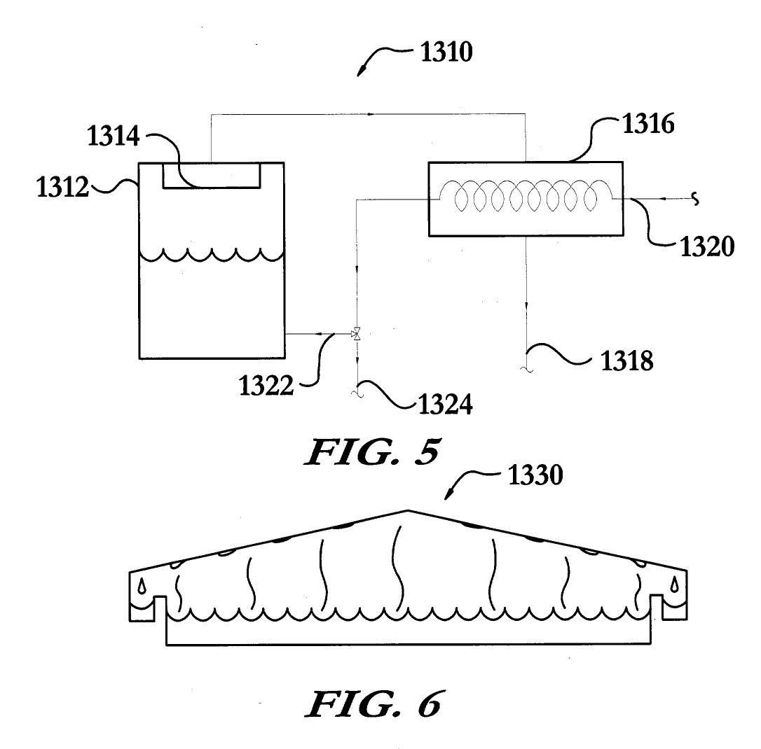

In one embodiment the disinfection system 1400 includes a chlorination system. The chlorination system is used to destroy organic impurities, including pathogenic and non-pathogenic organics. The chlorination system may inject chlorine gas or liquid chlorine into the water. In an alternative embodiment the disinfection system 1400 includes an ultraviolet light disinfection system. Ultraviolet light disinfection systems eliminate the taste and smell of chlorinated water and are suitable for point-of-use water systems such as that of the instant invention. Additionally, unlike chlorination systems, ultraviolet light disinfection produces no trihalomethanes, which are possible human carcinogens recognized by the United States Department of Agriculture, in the treated water. In yet another embodiment, the disinfection system 1400 includes an ozone disinfection system. Ozone (O₃) can be formed from environmental oxygen on-site by high voltage electrical discharge, and acts as a powerful oxidant capable of disinfecting water. Ozone is considered more reactive than chlorine or permanganate disinfection and has a high kill-rate for micro-organisms. Alternatively, as shown in FIG. 4, the apparatus 50 may incorporate a distillation system 1300 to guarantee that the water is free of organics, undissolved solids, biological contaminants, including pyrogens, and practically all ionizables. The distillation system 1300 may incorporate any number of distillation systems 1300 including, but not limited too, a single-effect distillation system 1310, seen in FIG. 5, and a solar distillation system 1330, seen in FIG. 6. Regardless of the particular embodiment, the principle of distillation is that water must pass through two phase changes, from liquid to vapor and back to liquid.

The single-effect distillation system 1310 of FIG. 5 may incorporate at least one still tank 1312, at least one baffle 1314, a condenser 1316, and numerous connection points. Heat is added to the water in the at least one still tank 1312 until the water changes states from liquid to vapor. Heat may be added to the at least one still tank 1312 via a steam heat exchanger, electric heating device, or other fossil fuel burner system. In one preferred embodiment the at least one still tank 1312 uses the same fuel as the vehicle 1000 and the mobile electrical power system 900, namely diesel fuel. As the water vapor rises to the tank outlet it must pass through at least one baffle 1314. The at least one baffle 1314 ensures that any water droplets that may contain contaminants are preventing from passing on with the water vapor. The vapor then flows to the condenser 1316 where the vapor condenses and creates distillate. Distillate may then be discharged through the distillate discharge 1318 for distribution or storage. The condenser 1316 is cooled from a cooling-water and feed water supply 1320. The cooling-water and feed water supply 1320 serves not only to cool the condenser 1316 but also to preheat the feed water supply 1322 so that less energy must be added in the still tank 1312 to change the water from liquid to vapor. Since, as one with skill in the art will appreciate, the condenser 1316 requires more water to condense the vapor than the still tank 1312 requires to make-up for the produced vapor, additional cooling water 1324 may be discharged back to its source or returned to the storage system 300. Both the still tank 1312 and the condenser 1316 may be outfitted with automatic controls including automatic blow-down and drain-down systems.

The solar distillation system 1330, illustrated in FIG. 6, generally consists of a dark colored pan, a transparent roof, and collection gutters. The sun shines through the roof and warms the water in the pan causing it to evaporate and rise to the roof where is condenses and runs into the collection gutters. The solar distillation system 1330 may be mounted on the roof of the vehicle or it may be field assembled. Further, a field constructible solar distillation system may include a self-contained inflatable system.

Referring again to FIG. 1, water may then exit the storage system 300 by gravity flow or via a booster pump system 500. In one simple embodiment, the booster pump system 500 may consist of little more than a submersible pump and associated controls. More advanced embodiments may include numerous positive displacement high pressure pumps. Use of high pressure pumps provides several advantages. Having the capability of producing pressures of several thousand pounds per square inch permits the use of such high pressure water as a tool both for cleaning and cutting, as well as reduced pressure distribution.

The water may then pass through a heating system 600 or go directly to a distribution system 700. As one with skill in the art can appreciate, any number of water heating systems 600 may be utilized. In low pressure applications, those with pressures of less than about one hundred and twenty psi, common water heating devices may be used. It is preferable to use energy sources other than electricity to minimize the load on the mobile electrical power system 900. In high pressure applications, those ranging from about one hundred and twenty psi up to several thousand psi, special water heating systems must generally be used. It is generally desirable for the heating system 600 to have the capability of producing at least a 100 degree F. temperature rise at the booster pump system 500 optimal flow rate. It is generally preferred for the heating system 600 to utilize the same fuel as the vehicle 1000 and the mobile electrical power system 900, namely diesel fuel. The heating system 600 may include adjustable thermostatic control as well as high-temperature and high-pressure protective devices.

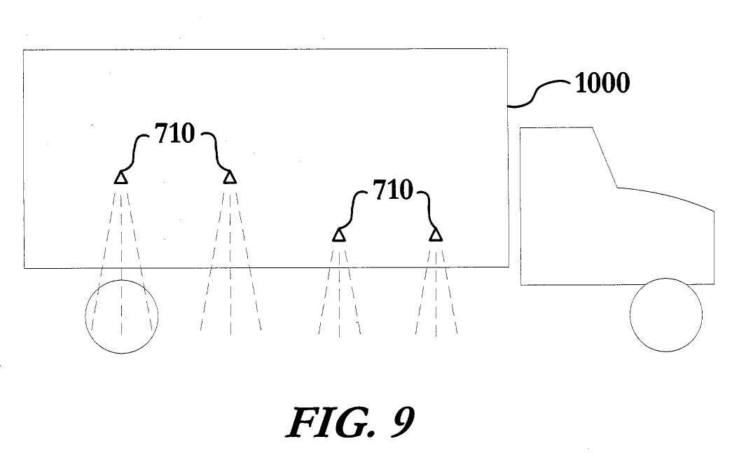

The water may then proceed to the distribution system 700. The distribution system 700 may incorporate final point of consumption devices, such as shower heads 710, spigots, and drinking fountains, as well as mechanisms for connection to other bulk distribution equipment, such as quick-connect hose couplings. Such final point of consumption devices may incorporate a number of safety features including, but not limited too, scald protection and high pressure protection. In one particular embodiment, shown in FIG. 9, a plurality of shower heads 710 are mounted on the side of the vehicle 1000 in such a fashion as to be adjustable in height to facilitate use by adults and children. In embodiments directed to power washing, the distribution system 700 may include a plurality of high pressure hoses, a high pressure spray gun, numerous pressure nozzles, foaming attachments, underbody spray attachments, brush attachments, and drain cleaning attachments.

Now referring to FIG. 2, the mobile electrical power system 900 generates electrical power for use by all the power consuming devices in the apparatus 50, and may generate additional power for distribution external to the apparatus 50. The mobile electrical power system 900 incorporates at least one generator 910, at least one distribution panel 920, and a plurality of conductors 930. The plurality of conductors 930 are preferably routed to the power consuming devices in rigid conduit. The joints and fitting in such conduit may further be sealed with firestopping material. The apparatus 50 may further include a solar energy collection system 1100 in electrical communication with at least the mobile electrical power system 900. The solar energy collection system 1100 may be used to maintain the charge of any batteries associated with the mobile power system 900 or the vehicle 1000.

The apparatus may also include a desalination system 800, as seen in FIG. 1. Seawater units are referred to as desalinators and surface/well water units are called reverse osmosis systems 400, as dedicated desalination units are generally capable of handling higher salt loads than conventional water reverse osmosis systems 400. The addition of a separate desalination system 800 will enable the instant invention to utilize sea water or highly brackish water, as well as sources from contaminated lakes or streams detailed above, in a more efficient manner. There are significant differences in the equipment used for removing most of the dissolved solids from seawater and that used with most surface or well waters. Seawater has about 35,000 mg/l of dissolved solids. Reverse osmosis systems 400 for fresh or brackish water on the other hand normally treat water where the dissolved solids content is in the area of 6,000 mg/l or less. To insure an adequate flow of water from the respective devices, desalination systems 800 usually operate in the area of 1,000 psi and reverse osmosis systems 400 in a range of 250 psi or less. This additional pressure requirement for desalination systems 800 increases the required strength of almost all components and requires much larger pumps. Also, seawater is extremely corrosive so the materials of construction for desalination systems 800 must be non-corrosive. All of these differences cause the cost of desalination systems 800 to be much higher than the cost of an equivalent gallon output reverse osmosis system 400. Providing a separate desalination system 800 allows the instant invention to only utilize desalination capacity when necessary for the project at hand.

Referring again to FIG. 4, alternative embodiments of the apparatus 50 may include a compressed air system 1200 and/or an auxiliary fluid distribution system 1700. The compressed air system 1200 may incorporate an air compressor, storage tank, distribution hoses, and associated compressed air tools. The auxiliary fluid distribution system 1700 may include accessories for distributing fluids other than those previously described. Such fluids may include fluids such as cleaning agents and fuels that should be distributed entirely independent of the water systems.

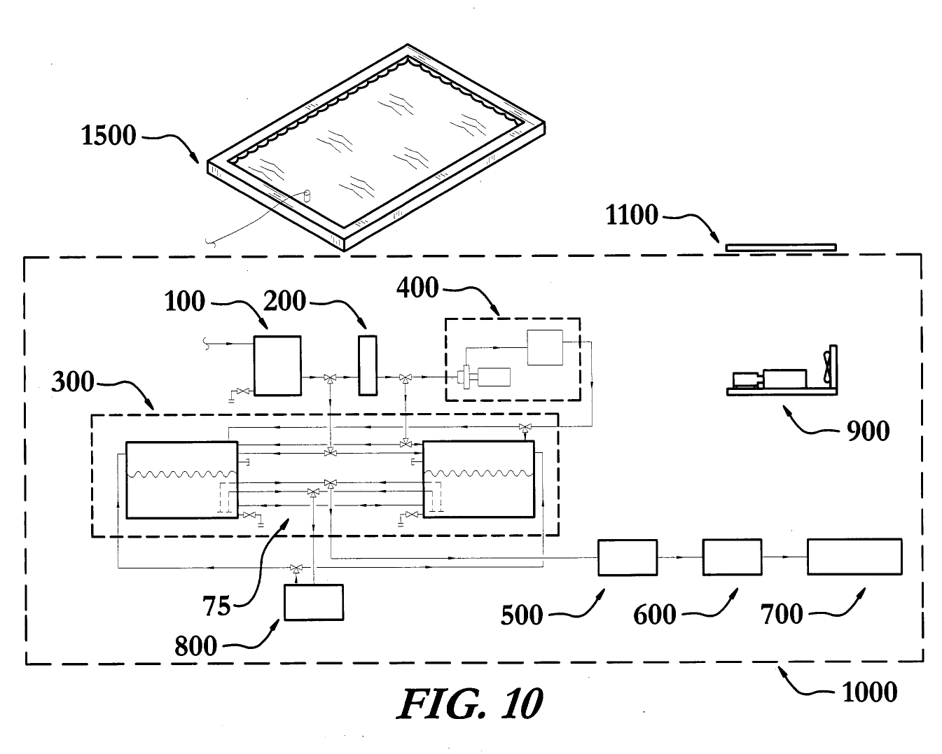

In yet another alternative embodiment the apparatus 50 may include a rain water collection system 1500, as seen in FIG. 10. The rain water collection system 1500 may consist of a large tarp-like structure that may be laid upon the ground. It may include dams around the perimeter of the tarp-like structure thereby creating a shallow pool to catch and retain rainwater. Such perimeter dam structures may be inflatable to ensure that the rain water collection system 1500 may be rolled up into the smallest volume for storage when not in use. Further, the tarp-like structure may be mounted on a storage and distribution accessory on the vehicle such that the structure may be deployed directly from the vehicle as it is in motion. Water captured in the rain water collection system 1500 may then be transferred to the storage system 300 for later processing, or may be transferred directly to the raw water filtration system 100.

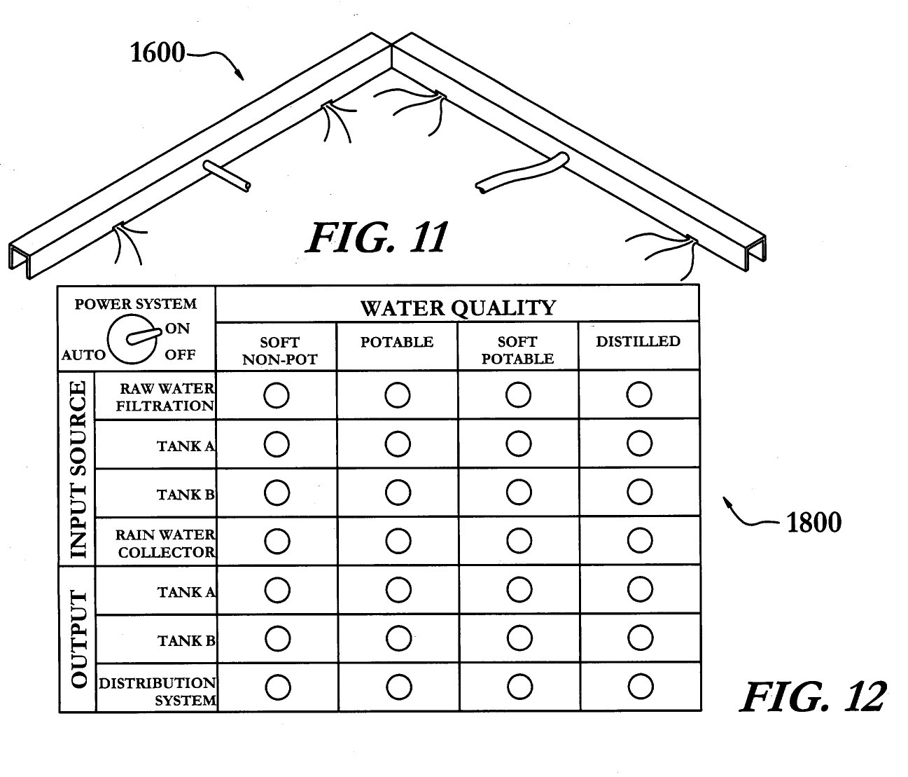

A further embodiment may include a fluid containment and recovery system 1600 as illustrated in FIG. 11. A flexible dam encloses a surface area to which water is applied. A vacuum source directed into the flexible dam both causes the dam to seal to the surface area and causes water to be returned to the apparatus 50. This minimizes the amount of water wasted as run-off and allows the instant invention to operate with a minimum of new water input.

As one with skill in the art can appreciate, the control of the apparatus 50 may be entirely automated with pneumatic or electronic controls. For example, the valves shown in the piping system 75 may be automatic control valves with failsafe positions. Similarly, control of the various elements of the apparatus 50 may be automated and controlled from a central control system 1800. The central control system 1800 may include a simple control system panel such as the one shown in FIG. 12. Such a central control system 1800 may allow the user to select the source from where the input water is to be drawn, the quality of the final water, and where the final water is to be stored. Such system may include numerous sensors installed throughout the apparatus to continuously monitor, and record, the characteristics of the water at various points in the apparatus 50. Additionally, for severe duty applications, each component of the apparatus may be installed for redundant operation thereby creating a full back-up system.

Numerous alterations, modifications, and variations of the preferred embodiments disclosed herein will be apparent to those skilled in the art and they are all anticipated and contemplated to be within the spirit and scope of the instant invention. For example, although specific embodiments have been described in detail, those with skill in the art will understand that the preceding embodiments and variations can be modified to incorporate various types of substitute and or additional or alternative materials, relative arrangement of elements, and dimensional configurations. Accordingly, even though only few variations of the present invention are described herein, it is to be understood that the practice of such additional modifications and variations and the equivalents thereof, are within the spirit and scope of the invention as defined in the following claims. The corresponding structures, materials, acts, and equivalents of all means or step plus function elements in the claims below are intended to include any structure, material, or acts for performing the functions in combination with other claimed elements as specifically claimed.

I claim:

1. A water storage, recovery, and treatment apparatus, comprising:
a raw water filtration system having a raw water inlet and a raw water outlet;
a sodium ion exchange system;
a reverse osmosis system;
a storage system;
a desalination system;
a heating system;
a distribution system;
a piping system, having at least one valve, placing the raw water filtration system, the sodium ion exchange system, the reverse osmosis system, the storage system, the desalination system, the heating system, and the distribution system in fluid communication;
a mobile electrical power system in electrical communication with at least the reverse osmosis system, the desalination system, and the heating system; and
a vehicle for transporting the apparatus.

2. The apparatus of claim 1, further including a booster pump system in fluid communication with the piping system and in electrical communication with the mobile electrical power system.

3. The apparatus of claim 1, further including a solar energy collection system in electrical communication with at least the mobile electrical power system.

4. The apparatus of claim 1, further including a compressed air system in electrical communication with the mobile electrical power system.

5. The apparatus of claim 1, further including a distillation system in fluid communication with the piping system.

6. The apparatus of claim 5, wherein the distillation system is a mobile solar distillation system.

7. The apparatus of claim 5, wherein the distillation system is a single-effect distillation system.

8. The apparatus of claim 7, wherein the single-effect distillation system comprises at least one still tank, at least one baffle, and at least one condenser in fluid communication with the piping system.

9. The apparatus of claim 1, further including a disinfection system in fluid communication with the piping system.

10. The apparatus of claim 9, wherein the disinfection apparatus is a chlorination system.

11. The apparatus of claim 9, wherein the disinfection system is an ultraviolet light disinfection system.

12. The apparatus of claim 9, wherein the disinfection system is an ozone disinfection system.

13. The apparatus of claim 1, further including at least one rainwater collection system in fluid communication with the piping system.

14. The apparatus of claim 1, further including at least one fluid containment and recovery system in fluid communication with the piping system.

15. The apparatus of claim 1, wherein the raw water filtration system comprises at least one sand filter.

16. The apparatus of claim 1, wherein the raw water filtration system comprises at least one diatomaceous earth filter.

17. The apparatus of claim 1, wherein the raw water filtration system comprises at least one separator, at least one coalescing plate, at least one oil skimmer, at least one reticulated media filter, at least one filter bag, at least one discharge pump, and at least one final filter.

18. The apparatus of claim 1, wherein the sodium ion exchange system comprises at least one softener tank and at least one brine tank.

19. The apparatus of claim 1, wherein the storage system comprises at least a potable water storage tank and a non-potable water storage tank.

20. The apparatus of claim 1, wherein the reverse osmosis system comprises at least one RO pump, at least one RO prefilter, and at least one RO membrane.

21. The apparatus of claim 20, wherein the at least one RO membrane is capable of removing from input water at least 87% of lead, 80% of calcium, 80% of magnesium, 90% of iron, 96% of lead, and 95% of total dissolved solids.

22. The apparatus of claim 1, wherein the booster pump system comprises at least one positive displacement high pressure pump.

23. The apparatus of claim 1, wherein the heating system is capable of producing at least a 100 degree F. temperature rise at the booster pump system optimal flowrate.

24. The apparatus of claim 1, wherein the distribution system comprises at least one shower head.

25. A water storage, recovery, and treatment apparatus, comprising:
a raw water filtration system comprising at least one separator, at least one coalescing plate, at least one oil skimmer, at least one reticulated media filter, at least one filter bag, at least one discharge pump, and at least one final filter, the raw water filtration system having a raw water inlet and a raw water outlet;
a sodium ion exchange system further including at least one softener tank and at least one brine tank;
a reverse osmosis system further including at least one RO pump, at least one RO prefilter, and at least one RO membrane, wherein the at least one RO membrane is capable of removing from input water at least 87% of lead, 80% of calcium, 80% of magnesium, 90% of iron, 96% of lead, and 95% of total dissolved solids;
a storage system storage system further including at least a potable water storage tank and a non-potable water storage tank;
a desalination system;
a heating system capable of producing at least a 100 degree F. temperature rise at the booster pump system optimal flowrate;
a distribution system comprising at least one shower head;
a piping system, having at least one valve, placing the raw water filtration system, the sodium ion exchange system, the reverse osmosis system, the storage system, the desalination system, the heating system, and the distribution system in fluid communication;
a mobile electrical power system in electrical communication with at least the reverse osmosis system, the desalination system, and the heating system;
a booster pump system in fluid communication with the piping system and in electrical communication with the mobile electrical power system;
a compressed air system in electrical communication with the mobile electrical power system;
a disinfection system in fluid communication with the piping system;
at least one fluid containment and recovery system in fluid communication with the piping system; and
a vehicle for transporting the apparatus.

26. A water storage, recovery, and treatment apparatus, comprising:
a raw water filtration system having a raw water inlet and a raw water outlet;
a sodium ion exchange system further including at least one softener tank and at least one brine tank;
a reverse osmosis system further including at least one RO pump, at least one RO prefilter, and at least one RO membrane, wherein the at least one RO membrane is capable of removing from input water at least 87% of lead, 80% of calcium, 80% of magnesium, 90% of iron, 96% of lead, and 95% of total dissolved solids;
a storage system storage system further including at least a potable water storage tank and a non-potable water storage tank;
a desalination system;
a heating system capable of producing at least a 100 degree F. temperature rise at the booster pump system optimal flowrate;
a distribution system comprising at least one shower head;
a piping system, having at least one valve, placing the raw water filtration system, the sodium ion exchange system, the reverse osmosis system, the storage system, the desalination system, the heating system, and the distribution system in fluid communication;
at least one rainwater collection system in fluid communication with the piping system;
a distillation system comprising at least one still tank, at least one baffle, and at least one condenser, the distillation system in fluid communication with the piping system;
a mobile electrical power system in electrical communication with at least the reverse osmosis system, the desalination system, and the heating system;
a solar energy collection system in electrical communication with at least the mobile electrical power system;
a booster pump system in fluid communication with the piping system and in electrical communication with the mobile electrical power system;
a compressed air system in electrical communication with the mobile electrical power system;
a disinfection system further comprising a chlorination system in fluid communication with the piping system;
at least one fluid containment and recovery system in fluid communication with the piping system;
a vehicle for transporting the apparatus; and
a central control system designed to automatically control at least the raw water filtration system, the sodium ion exchange system, the reverse osmosis system, the storage system, the heating system, the booster pump system, and the disinfection system.
